(19) United States
(12) Patent Application Publication
(10) Pub. No.: US 2016/0196427 A1
(43) Pub. Date: Jul. 7, 2016

(54) System and Method for Detecting Branch Oriented Programming Anomalies

(71) Applicant: LEVIATHAN, INC., Seattle, WA (US)

(72) Inventors: Mikhail Davidov, Seattle, WA (US); Darren Kemp, Calgary (CA); Sean Bradly, Austin, TX (US)

(73) Assignee: LEVIATHAN, INC., Seattle, WA (US)

(21) Appl. No.: 14/793,983

(22) Filed: Jul. 8, 2015

Related U.S. Application Data
(60) Provisional application No. 62/022,050, filed on Jul. 8, 2014.

(51) Int. Cl. G06F 21/54; G06F 21/55

(52) U.S. Cl. CPC G06F 21/54; G06F 21/554; G06F 2221/033

(57) ABSTRACT

Systems, methods and media are shown for detecting branch oriented program code involving searching one or more pages of memory to identify a list of code pointers. They also involve, for each code pointer in the list of code pointers, disassembling a segment of code corresponding to the code pointer, determining whether the segment of code terminates in a branch instruction, and removing the segment of code from the list if it does not terminate in a branch instruction. For each remaining code pointer in the list of code pointers, they involve searching a predetermined window of code to determine whether the branch instruction and a target address of the branch instruction both fall within the window, and removing the code pointer from the list if the branch instruction and target address are not both within the window.

### CROSS REFERENCE TO RELATED APPLICATIONS

This application claims the benefit of U.S. Provisional Patent Appl. No. 62/022050 for “System and Method for Detecting Branch Oriented Programming Anomalies” filed Jul. 8, 2014, herein incorporated by reference in its entirety for all purposes.

### GOVERNMENT LICENSE RIGHTS

This invention was made with government support under FA8750-12-C-0161 awarded by the United States Air Force. The government has certain rights in this invention.

### BACKGROUND

Computer networks and the devices and services that reside on them are often the subject of attacks by parties that are attempting to improperly access information and resources or to introduce malicious code to the networks. Branch-oriented programming (BOP) relies on short runs of code already present and executable in a target program's address space. One type of BOP attack is based on return oriented programming (ROP), wherein attackers use the call stack and a function return primitive to link or chain together short runs of code already present in a program's address space in order to gain control of programs without relying on code injection. Another form of BOP attack is jump-oriented programming (JOP), in which an attacker links code together by providing a program control flow routine (commonly called a dispatcher) combined with a series of pointers to short runs of code that form the JOP program.

### SUMMARY

According to one aspect of the present invention, examples of a method, a system, and a persistent computer media having instructions for detecting branch oriented program code are shown involving searching the pages of memory to identify a list of code pointers and, for each code pointer in the list of code pointers, disassembling a segment or block of code corresponding to the code pointer, determining whether the segment of code terminates in a branch instruction, and removing the segment or block of code from the list if it does not terminate in a branch instruction. The method also involves, for each remaining code pointer in the list of code pointers, searching a window of code to determine whether the branch instruction and the target address of the branch instruction both fall within the window and removing the segment of code from the list if the branch instruction and target address are not both within the window.

In one refinement of the method, the search of the pages of memory includes searching the pages of memory based on each possible pointer or address alignment for an architecture corresponding to the code in the pages of memory.

In another refinement of the method, the method further involves, for each remaining code pointer in the list of code pointers, determining whether the branch instruction in the segment of code pointed to terminates in any type of branch instruction, and if so, flagging the code pointer as a gadget pointer.

In still another refinement of the method, the method further involves, for each remaining code pointer in the list of code pointers, determining whether the identified branch instruction which ends the gadget occurs before the appearance of any instruction which is invalid or invalid in context, or the appearance of any offset at which nothing exists (i.e. the beginning of uncommitted memory), or a number of otherwise valid instructions representing a gadget size threshold, and, if so, flagging the code segment as a likely BOP gadget.

### BRIEF DESCRIPTION OF THE DRAWINGS

Various embodiments in accordance with the present disclosure will be described with reference to the drawings, in which:

FIG. 1 is a schematic diagram depicting an example of a computer network based system that may be subject to attack and may be suitable for utilization of certain aspects of the present invention;

FIG. 2 is a schematic diagram illustrating an example of a branch oriented program exploit;

FIG. 3 is a control flow diagram illustrating an example of a process for inspecting pages of memory to identify possible BOP exploit code;

FIG. 4 is a control flow diagram illustrating an example of a process for refining the list of BOP gadgets identified in the process of FIG. 3 into a list of likely BOP gadgets which fall within aggregations of likely BOP gadgets though disassembly of the BOP gadgets and checking the co-proximity of the BOP gadget pointers in accordance with some aspects of the present invention;

FIG. 5 is a control flow diagram illustrating an example of a process for further analysis of data that may be an aggregation of pointers to BOP gadgets; and

FIG. 6 depicts aspects of elements that may be present in a computer device and/or system configured to implement a method, system and/or process in accordance with some embodiments of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Examples of methods and systems are shown for detecting BOP exploit code as described below.

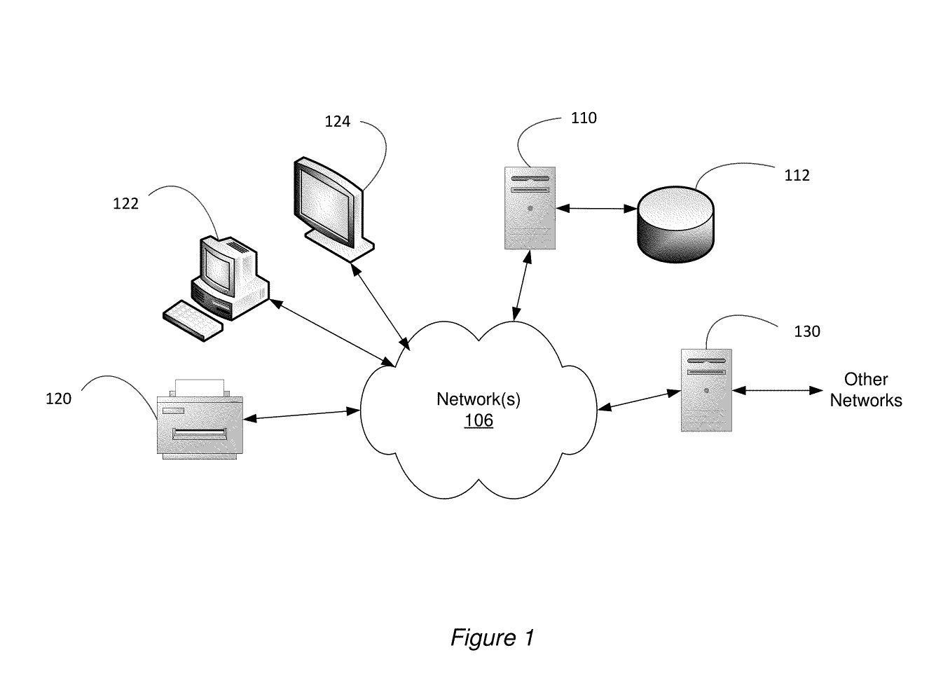

FIG. 1 is an architecture diagram that depicts aspects of an example of a computer network system with communication among multiple devices. In this example, network 106, which can be one network or multiple networks, provides communication between server 110 connected to database 112 and several client devices, such as printer 120, personal computer 122, and interactive terminal 124. The architecture of FIG. 1 is a simplified representation of an enterprise environment having a multitude of different computing devices that may represent a target for an attack. A gateway 130 provides a communications link between the network 106 and other networks, such as the internet, through which an attacker may launch an attack.

A new class of code-reuse attack, called branch-oriented programming (BOP), which includes jump-oriented programming (JOP) and return-oriented programming (ROP), has emerged that exploits short runs of code already present and executable in a target program's address space to form a BOP program. In both cases, BOP code is composed of short runs of code already present and executable in a target program's address space. In the case of ROP, the attacker links code together by utilizing the call stack and a function return primitive (such as a RET instruction on x86). In the case of JOP, the attacker links code together by providing a program control flow routine (commonly called a dispatcher) combined with a series of pointers to the short runs of code forming the JOP program. In both cases parameters may also be present in some form, whether or not inline. Both of these techniques enable attackers to overcome certain mitigation techniques and gain control of exploitable programs without executing attacker-introduced code.

Return-oriented programming (ROP) is an effective code-reuse attack in which short code sequences ending in a ret instruction are found within existing binaries and executed in arbitrary order by taking control of the call stack. This allows for Turing-complete behavior in the target program without the need for injecting attack code, thus significantly negating current code injection defense efforts (e.g., W⊕X). On the other hand, its inherent characteristics, such as the reliance on the stack and the consecutive execution of return oriented gadgets, have prompted a variety of defenses to detect or prevent it from happening.

For an example of JOP, see Bletsch et al., “Jump-Oriented Programming: A New Class of Code-Reuse Attack,” Proceedings of the 6th ACM Symposium on Information, Computer and Communications Security, 2011. The JOP based attack eliminates the reliance on the stack and return instructions seen in return-oriented programming, but, like ROP, builds and chains functional gadgets, e.g. small segments of functional code, each performing certain primitive operations, except that the JOP gadgets end in an indirect branch rather than a return as in ROP. Without the use of the return instruction to unify the gadgets, a JOP attack relies on a dispatcher gadget to dispatch and execute the functional gadgets.

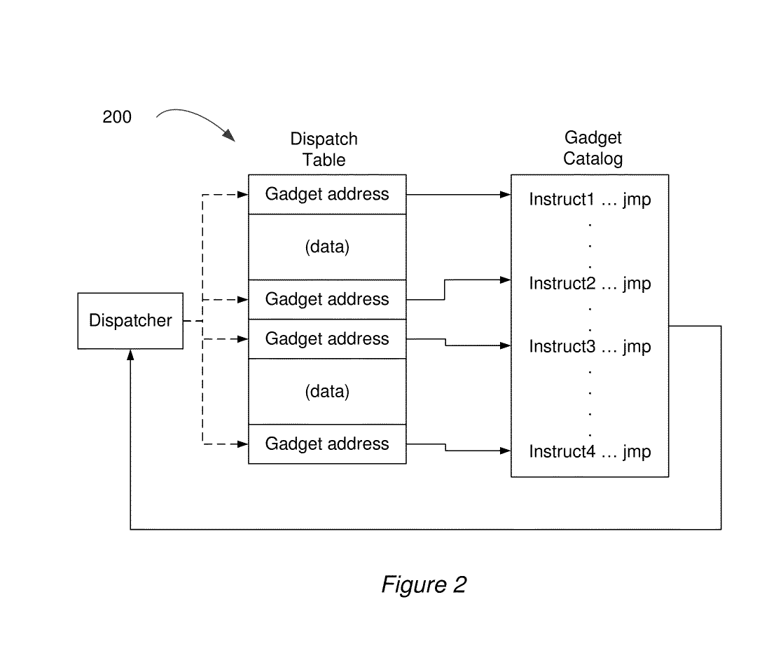

FIG. 2 is a functional block diagram illustrating a simplified example of the structure of a BOP attack, which, in this case, is a JOP attack Like a ROP attack, a JOP attack program consists of a set of gadget address and data values loaded into memory, which is stack memory for ROP, where the gadget addresses function analogously to instructions within a jump oriented machine. JOP uses a dispatch table to hold gadget addresses and data and any register that points into the dispatch table may function as a virtual program counter for the JOP program. ROP manipulates the call stack to link or chain together gadgets to form a BOP program. Control flow is driven by a dispatcher gadget that executes the sequence of gadgets and advances the virtual program counter at each invocation in order to launch an associated gadget. By not relying on the stack for control flow, the JOP attack can potentially use any memory range, contiguous or non-contiguous, to hold the dispatch table. JOP relies on indirect jump and call instructions, which are typically identified in existing code through a discovery algorithm to form a gadget catalog.

Many instruction set architectures, including x86, have variable-length instructions. The function of an instruction in a variable-length instruction set depends to varying degrees on an entire instruction. The function of an instruction can be significantly changed by removing one or more bytes from the beginning of the instruction. This is particularly true in cases where an instruction contains a mandatory prefix byte that is an escape byte or in cases where a prefix is used to modify the length of a parameter to the instruction, among others. It is also likely that changing the initial offset will change the function of subsequent instructions because each subsequent instruction begins immediately following the last byte of the preceding one.

It is occasionally possible for an attacker to branch execution to offsets in the middle of an instruction, resulting in modified behavior. This serves two functions: obfuscation of the function of an attack payload and the ability to transform the function of existing bytecode. Legitimate programs typically follow their own blockgraph and rarely split instructions. An example of an exception is LOCK prefix splitting in x86 architectures. Instruction splitting is, therefore, a strong indicator of malicious code execution. The correct alignment of an instruction can be determined by parsing the section of bytecode in which it falls by starting from a known-good offset. Exported symbols and a program's entry point are examples of known-good offsets. Each subsequent offset at which a new instruction starts can then also be considered to be a known-good offset. Branches to offsets other than known-good offsets are not part of normal program operation and are highly likely to be the result of exploitation of software vulnerabilities provided that the unaligned offsets do, in fact, produce a series of executable instructions with a different function.

Additionally, because the instructions in most microarchitectures are considerably more basic than the logical components of a programmer's intentions, merely removing the initial part of a programmer's function and rearranging the order of execution without splitting instructions (or in a fixed-instruction-width microarchitecture) is also able to substantially change the function of a program. Accordingly, for the purposes of detecting jump-oriented programming, branches to offsets in code blocks that would not normally be branched to in the course of program execution, e.g. branches to the middle of a program rather than an entry point, may be treated the same way as branches to the middle of instructions, i.e. instruction splitting.

In certain embodiments of the present invention, detecting these jumps involves disassembly of the program under test to determine a control flow graph and the individual basic blocks of the program. In this context, a basic block begins at the first offset into a block of code, such as the address of a symbol representing a function to be called, the entry point of a program, or the destination address of a branch instruction residing in a known legitimate portion of code. The basic block ends at any instruction that would cause execution to cease or to branch, which includes instructions that are likely to generate a CPU exception, any branch instruction (such as RET in x86 architectures), and any invalid instruction. For the purposes of this determination, a conditional jump instruction or a call instruction cause the start of a basic block to be at both the destination and the following instruction. A return instruction does not introduce another basic block and is treated as terminal for the purposes of disassembly. The nodes of the blockgraph are used here for JOP detection rather than the edges of the graph.

A BOP program, as a malicious payload, generally has several defining characteristics regardless of the specifics of its dispatcher or the method in which it was injected. For example, it will typically occupy a contiguous and limited area of memory, and contain the addresses of the gadgets it uses. The property of contiguity is not essential, except that it implies the addresses contained in the payload will be tightly clustered. There will also typically be a finite number of addresses in a BOP program. These and similar properties may be used to filter out the noise introduced by interpreting every stream of bytes encountered that appears to include an address as such, and refine a list of possible BOP attacks into a set of instructions that has a high probability of being a BOP chain. However, while it is normally a constraint for BOP attacks to have a finite number of gadget addresses, it is not necessarily the case that the addresses will be contiguous. Another characteristic is that the BOP chain normally exists within read/write memory, since the attacker must have some way to inject it into process memory, and the computer must be able to read and execute the BOP chain.

In certain embodiments of the present method, the method involves searching each page of memory from each alignment (there are 4 possible alignments in 32-bit systems and 8 in 64-bit systems) for sequences which appear to be code pointers (that is, numbers which correspond to an address which is within the program blockgraph) to build an unrefined list of potential gadget pointers. This list may then be refined by detecting whether these addresses actually point at a gadget-like sequence of code, and refined still further by determining their proximity to other such pointers in memory.

One refinement detects whether a BOP gadget is present at an address by disassembling from that address for some set number of instructions. This parameter will generally be selected to reflect the longest gadget that is expected to be found. In practice, gadgets tend to be short because they are intended to be building blocks for arbitrary functionality and must thus be somewhat nonspecific, which generally implies shortness. If the resulting disassembly ends in a branch instruction, then it is possible for the referenced code to be a gadget. If it does not, the code segment is excluded and the address is removed from the list possible BOP gadgets.

A second refinement considers the proximity of each address in the refined list to other such addresses. A sliding window search may be made, where the window size and, optionally, a threshold, e.g. minimum number of gadget addresses to be contained within the window, may be fixed or adjustable parameters. If a branch instruction and the target address to which it branches are found within the sliding window, then it is inferred that a BOP program's jump table or call stack resides near that location in memory and an attempt to exploit the application under analysis using a BOP exploit is evident.

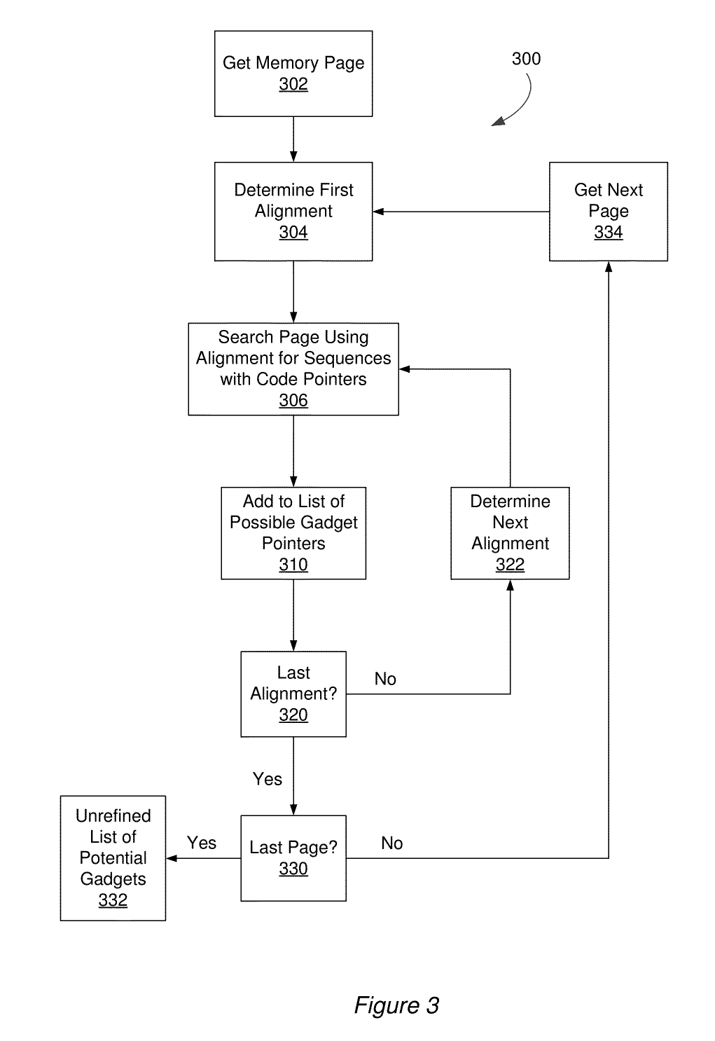

FIG. 3 is a control flow diagram illustrating an example of a process 300 for identifying potential BOP gadget pointers in accordance with certain aspects of the present invention. In this example, multiple pages of memory are analyzed to create a list of possible gadget pointers. At step 302, the first memory page is obtained and, at step 304, a first instruction alignment is determined. At step 306, the memory page is searched using the first alignment to find sequences with code pointers. At step 310, the code pointer sequences are added to a list of possible gadget pointers.

In one example, a search of the pages of memory includes searching the pages of memory based on each possible address alignment for an architecture corresponding to the code in the pages of memory. For example, if the architecture address word length is 4 bytes, each of the page offset, the page offset plus one, the page offset plus two, and the page offset plus three would be used as starting offsets to search the page. Similarly, if it is two bytes (as in a 16-bit architecture), the page offset and the page offset plus one will be used for starting offsets. If the architecture uses 24-bit (3 byte) addresses and 32-bit (4 byte) data words, the +0, +1, and +2 alignments would be searched. This relies upon an underlying assumption that a jump table containing gadget addresses is likely to be a series of consecutive addresses in memory (beginning at an offset aligned to one of the start offsets), so that they can be accessed using a scale-index-base type mechanism. Additional JOP dispatcher complexity would be required to avoid this assumption, and payload complexity is undesirable to an attacker because it decreases reliability of the JOP dispatcher while generally increasing detectability of the attack. Similarly, a ROP chain is typically simple.

At step 320, a check is performed for the last instruction alignment. If the alignment used is not the last possible instruction alignment, then control branches to step 322 to determine the next alignment and control branches to step 306 to search the memory page for possible BOP gadgets using the new instruction alignment. Control will cycle through steps 306, 310, 320 and 322 until the page has been searched for all possible alignments, e.g. four alignments in 32-bit systems, eight alignments in 64-bit systems.

When the memory page has been analyzed for all alignments, control branches to step 330 to determine whether the memory page analyzed was the last page to be considered.

If the memory page just analyzed is not the last page, then control branches to step 334 to obtain the next page to be analyzed and analysis proceeds from step 304 as described above. If this was the final page, control branches to step 332 and creation of an unrefined list of potential BOP code segments or gadgets.

One aspect of the present invention involves disassembly from the original entry point and the starting offsets of all exports of a program to generate a list of aligned offsets in a program, and the offsets of legitimate code branch destinations, for the purpose of determining the maliciousness of a branch destination address. Another aspect is the transformation of a list of arbitrary and possibly unaligned pointers to fragments of program text by cross-referencing them with the original program text interpreted as a context-free byte stream and, in turn, the transformation of these program fragments into a list of blocks of program text (original or synthetic as the result of instruction splitting) that may be gadgets used by an attacker.

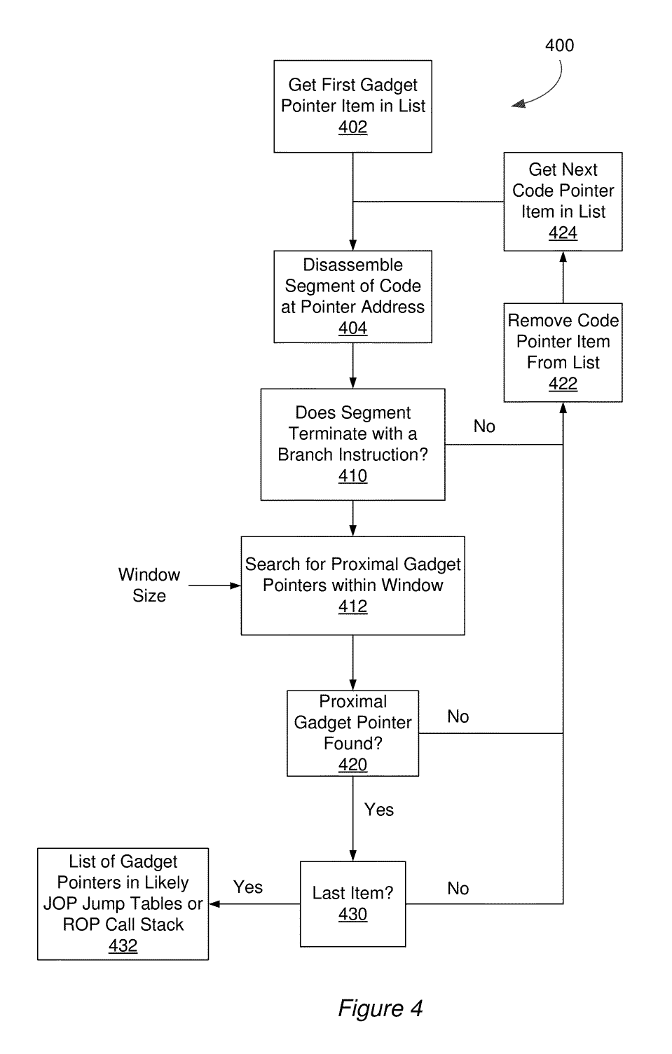

FIG. 4 is a control flow diagram illustrating an example of a process 400 for refining the list of potential BOP gadget pointers from process 300 of FIG. 3 in accordance with certain aspects of the present invention. In this example, the first item in the gadget pointer item list is obtained and disassembled at step 404. The disassembled code is then analyzed at step 410 to determine whether the segment terminates with a branch or return instruction. If not, then the code block lacks the jumping characteristic of a JOP gadget or the return characteristic of a ROP gadget and control branches to step 422 where the item is removed from the list, to step 424 to obtain the next item in the list, and to step 404 for disassembly and analysis of the next item.

An aspect of the present invention is inferring the existence of a BOP program where a certain number of proximal addresses of gadgets exist. In this example, if the segment is found to terminate with a branch instruction at step 410, then control flows to step 412 where a sliding window is used to search for proximal gadget pointers to the pointer dereferenced in step 404. The window size may, for example, be predetermined or adjusted and reflects the characteristic of JOP exploits that the jump table is usually small (i.e. the elements of the jump table forming the JOP program are co-proximal) and, similarly, that a ROP chain is relatively small and closely packed. If no proximal gadget pointers are detected at step 412, then control branches at step 420 to step 422 to remove the item from the list. Process 400 continues until the end of the list is encountered at step 430, at which point the process is completed having identified or not identified a BOP program or produced a refined list of BOP exploits 432. At this point, the process 400 has produced output that is useful for analysis of BOP exploits without proceeding to process 500 described below.

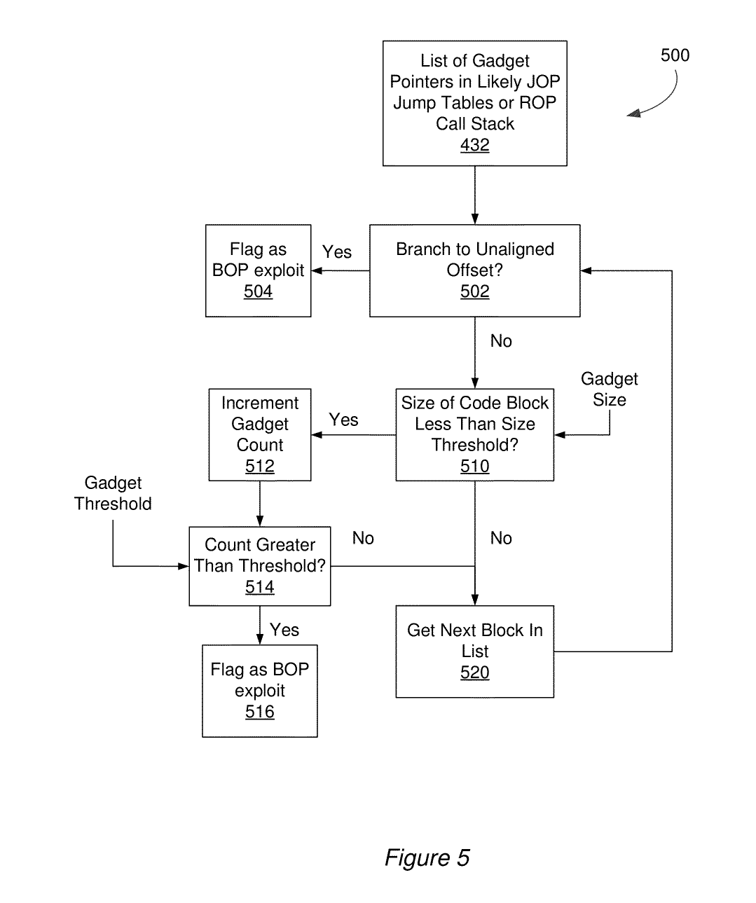

FIG. 5 is a control flow diagram illustrating an example of a process 500 for analyzing the refined list 432 produced by process 400 of FIG. 4 in accordance with certain aspects of the present invention. In this example, each suspected BOP code pointer from the list 432 is further analyzed in process 500. At step 502, if the block of code from the list contains a branch to an unaligned offset (e.g. splits an instruction), it is flagged at step 504 as being likely evidence of a BOP payload without regard to whether or not semantic evidence for its use as a branch destination actually exists. In another example, the jump or return address may be analyzed to determine whether the address is at the start of a basic block, or the beginning of an instruction given a trusted initial alignment, which is valid, or land in the middle of or splits a basic block or instruction, which is invalid. Also, the code may be checked for a branch into memory that is not enabled for read and write. In an additional example, for each remaining code pointer in the list of code pointers, determine whether the branch instruction in the segment of code pointed to terminates in some form of branch or return instruction and before the appearance of any instruction that is invalid or invalid in context, or the appearance of any offset at which nothing exists (i.e. the beginning of uncommitted memory), and, if so, flagging the code segment as a likely BOP gadget.

Still another aspect of the present invention is the use of gadget size as a heuristic, which may be adjustable, to ascertain the likelihood that a block of executable code starting from an unaligned offset is in fact of some use to an attacker. In this example, control branches to step 510 where the size of the code block segment is checked against a predetermined or adjustable gadget size, which reflects the characteristic of BOP gadgets to typically consist of small segments of code. Note that step 510 may be combined with step 410 of FIG. 4 in some examples. An additional aspect of the present invention involves the use of a threshold for the number of blocks likely of use to an attacker as a heuristic for determining whether the state of a program is the result of an attempt to manipulate the program using a software vulnerability. In this example, if the size of the block is less than the threshold gadget size at step 510, then a gadget count is incremented at step 512. At step 514, the gadget count is compared to a gadget threshold, which reflects the characteristic of JOP jump tables or ROP chains to typically consist of multiple segments of code. The gadget threshold may be predetermined or adjusted. If the count exceeds the gadget threshold, then the item is flagged as a BOP exploit at step 516. Otherwise, control branches to step 520 to analyze the next item in the refined list of BOP exploits 432.

In an alternative example, the process 500 of FIG. 5 may be altered to measure BOP program complexity as the number of discrete gadget pointers as a heuristic, which threshold may be adjustable, to ascertain the likelihood that a block of alleged pointers might be useful to an attacker. In this example, control branches to step 512 following step 504 in case step 502 was positive to increment the number of alleged gadget pointers proximal to other alleged gadget pointers found. In this example, step 510 may be eliminated by a branch directly to step 520 when step 502 is negative. Control from step 512 then proceeds to a step that determines if additional alleged BOP pointers remain. If so, control proceeds to step 520 for continued processing of the list of gadget pointers 432. If not, control progresses to step 514, where the count of such gadget pointers is compared against a threshold, which may be predetermined or adjustable. This reflects the characteristic of JOP jump tables or ROP chains to consist of numerous gadgets. If the count exceeds the threshold at step 514, the process reports the existence of a BOP exploit at step 516. If not, the process may report the nonexistence of a BOP exploit.

Various embodiments may take different approaches utilizing this heuristic. In one example, for each remaining code pointer in the list of code pointers, determine whether the size of the segment of code is less than a gadget size threshold and if so, flagging the code segment as a likely BOP gadget. In another example, for each remaining code pointer in the list of code pointers, given a disassembly of the program from known intended entry points, determine whether the offset of the code pointed to is aligned with the normal program flow (i.e. is not a split instruction) or splits an instruction only in a manner commonly done in the microarchitecture in use (e.g. splitting away the LOCK prefix in x86), and if it is not and does not, indicating that a BOP gadget that splits instructions was found, and programmatically assign an increased degree of confidence that the address is in fact a jump or return offset related to a BOP exploit. In an additional example, given the list of likely BOP gadgets that are referenced by an apparent jump table or ROP chain, determine whether those gadgets and the jump table in the aggregate represent evidence of a branch-oriented programming exploit or exploitation attempt with regard to certain properties thereof including, but not limited to, contiguity, beginning offset, metadata (e.g. heap allocation information; busy/free; writeability; adjacent corruption) pertaining to the location, and length of the alleged JOP table or ROP chain, and the confidence with which the addresses within the alleged JOP table or ROP chain are believed to reference BOP gadgets.

In accordance with at least one embodiment of the invention, the system, apparatus, methods, processes and/or operations described herein may be wholly or partially implemented in the form of a set of instructions executed by one or more programmed computer processors, such as a central processing unit (CPU) or microprocessor. Such processors may be incorporated in an apparatus, server, client or other computing device operated by, or in communication with, other components of the system. In accordance with another embodiment of the invention, the system, apparatus, methods, processes and/or operations described herein may be wholly or partially implemented in the form of a set of processor executable instructions stored on persistent storage media.

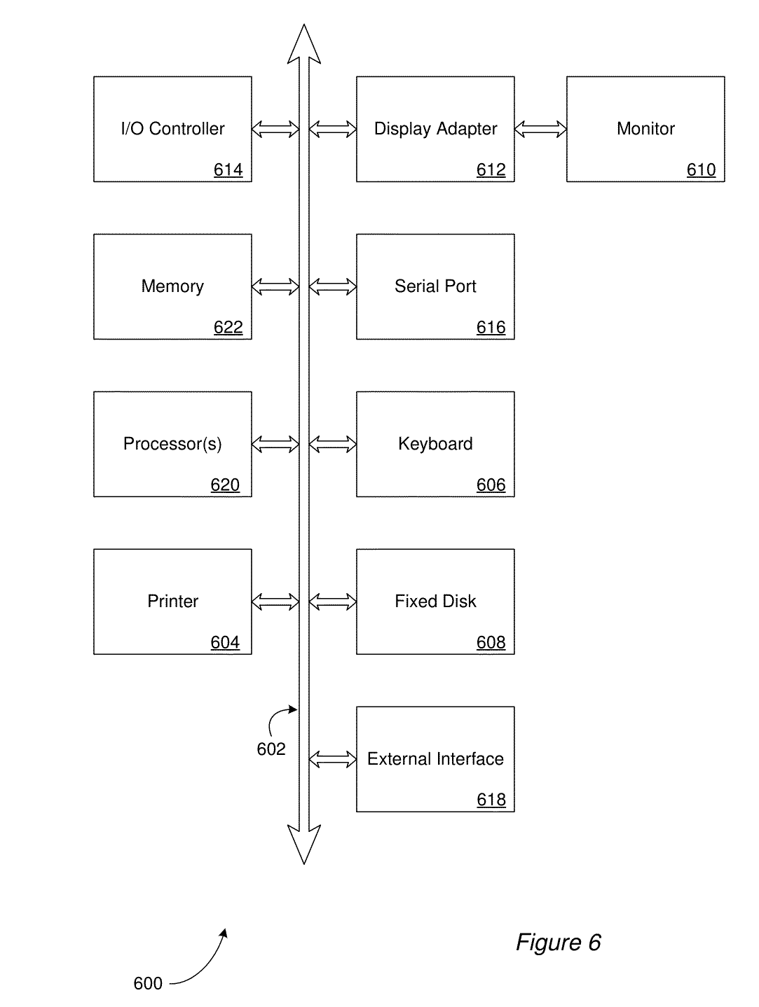

FIG. 6 depicts aspects of elements that may be present in one example of a computer device and/or system 600 configured to implement at least some elements of a method, system and/or process in accordance with some embodiments of the present invention. The subsystems shown in FIG. 6 are interconnected via a system bus 602. Additional subsystems include a printer 604, a keyboard 606, a fixed disk 608, and a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to further devices and/or systems not shown in FIG. 6 including a wide area network such as the Internet, a mouse input device, and/or a scanner. The interconnection via the system bus 602 allows one or more processors 620 to communicate with each subsystem and to control the execution of instructions that may be stored in a system memory 622 and/or the fixed disk 608, as well as the exchange of information between subsystems. The system memory 622 and/or the fixed disk 608 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl or using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM, where the code is persistently stored sufficient for a processing device to access and execute the code at least once. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components or steps depicted in the drawings or described above, as well as components and steps not shown or described, are possible without departing from the scope of the invention. Similarly, some features and subcombinations are useful and may be employed without reference to other features and subcombinations. Embodiments of the invention have been described for illustrative and not restrictive purposes, and alternative embodiments will be apparent to one of ordinary skill in the art. Accordingly, the present invention is not limited to the embodiments described above or depicted in the drawings, and various embodiments and modifications can be made without departing from the scope of the invention.

We claim:

1. A method for detecting branch oriented program code, the method comprising the steps of:
searching one or more pages of memory to identify a list of code pointers;
for each code pointer in the list of code pointers:
disassembling a segment of code corresponding to the code pointer,
determining whether the segment of code terminates in a branch instruction, and
removing the segment of code from the list if it does not terminate in a branch instruction; and
for each remaining code pointer in the list of code pointers:
searching a predetermined window of code to determine whether the branch instruction and a target address of the branch instruction both fall within the window, and
removing the code pointer from the list if the branch instruction and target address are not both within the window.

2. The method of claim 1, where the step of searching one or more pages of memory to identify a list of code pointers includes searching the one or more pages of memory based on each possible instruction alignment for an architecture corresponding to the code in the pages of memory.

3. The method of claim 1, the method further comprising the steps of, for each remaining code pointer in the list of code pointers:
determining whether the branch instruction in the segment of code terminates in at least one of an unaligned offset and an invalid destination; and
if so, flagging the code pointer as a potential BOP exploit payload.

4. The method of claim 1, the method further comprising the steps of, for each remaining code pointer in the list of code pointers:
determining whether a size of the segment of code is less than a predetermined gadget size threshold;
if so, incrementing a gadget count value;
determining whether the gadget count value exceeds a predetermined gadget threshold value; and
if so, flagging the code pointer as a potential BOP exploit payload.

5. A system for detecting branch oriented program code, the system comprising:
means for searching one or more pages of memory to identify a list of code pointers;
means for disassembling a segment of code corresponding to the code pointer for each code pointer in the list of code pointers, determining whether the segment of code terminates in a branch instruction, and removing the segment of code from the list if it does not terminate in a branch instruction; and
means for searching a predetermined window of code for each remaining code pointer in the list of code pointers to determine whether the branch instruction and a target address of the branch instruction both fall within the window, and removing the code pointer from the list if the branch instruction and target address are not both within the window.

6. The system of claim 5, where the means for searching one or more pages of memory to identify a list of code pointers includes means for searching the one or more pages of memory based on each possible instruction alignment for an architecture corresponding to the code in the pages of memory.

7. The system of claim 5, the system further comprising:
means for determining whether the branch instruction in the segment of code terminates in at least one of an unaligned offset and an invalid destination for each remaining code pointer in the list of code pointers and, if so, flagging the code pointer as a potential BOP exploit payload.

8. The system of claim 5, the system further comprising the steps of:
determining whether a size of the segment of code is less than a predetermined gadget size threshold for each remaining code pointer in the list of code pointers;
means for incrementing a gadget count value if size of the segment of code is less than the predetermined gadget size threshold;
means for determining whether the gadget count value exceeds a predetermined gadget threshold value; and
means for flagging the code pointer as a potential BOP exploit payload if the gadget count value exceeds the predetermined gadget threshold value.

9. A persistent computer readable medium storing computer code configured to a cause a processing device to operate to detect branch oriented program code, the computer code including instructions that configure the processing device to:
search one or more pages of memory to identify a list of code pointers;
for each code pointer in the list of code pointers:
disassemble a segment of code corresponding to the code pointer,
determine whether the segment of code terminates in a branch instruction, and
remove the segment of code from the list if it does not terminate in a branch instruction; and
for each remaining code pointer in the list of code pointers:
search a predetermined window of code to determine whether the branch instruction and a target address of the branch instruction both fall within the window, and
remove the code pointer from the list if the branch instruction and target address are not both within the window.

10. The persistent computer readable medium of claim 9, where the instructions configured to cause the processing device to search one or more pages of memory to identify a list of code pointers includes instructions to cause the processing device to search the one or more pages of memory based on each possible instruction alignment for an architecture corresponding to the code in the pages of memory.

11. The persistent computer readable medium of claim 9, the computer code further including instructions configured to cause the processing device to operate, for each remaining code pointer in the list of code pointers, to:
determine whether the branch instruction in the segment of code terminates in at least one of an unaligned offset and an invalid destination; and
if so, flag the code pointer as a potential BOP exploit payload.

12. The persistent computer readable medium of claim 9, the computer code further including instructions configured to cause the processing device to operate, for each remaining code pointer in the list of code pointers, to:
determine whether a size of the segment of code is less than a predetermined gadget size threshold;
if so, increment a gadget count value;
determine whether the gadget count value exceeds a predetermined gadget threshold value; and
if so, flag the code pointer as a potential BOP exploit payload.
